(19) United States
(12) Patent Application Publication
(10) Pub. No.: US 2025/0342682 A1
(43) Pub. Date: Nov. 6, 2025

(54) KEY-POINT ASSOCIATING APPARATUS, KEY-POINT ASSOCIATING METHOD, AND NON-TRANSITORY COMPUTER-READABLE STORAGE MEDIUM

(71) Applicant: NEC Corporation, Minato-ku, Tokyo (JP)

(72) Inventor: Yadong PAN, Tokyo (JP)

(73) Assignee: NEC Corporation, Minato-ku, Tokyo (JP)

(21) Appl. No.: 18/862,219

(22) PCT Filed: May 25, 2022
(86) PCT No.: PCT/JP2022/021354

§ 371 Date: Nov. 1, 2024

(51) Int. Cl. G06V 10/77; G06V 10/44; G06V 40/10

(52) U.S. Cl. CPC G06V 10/7715; G06V 10/457; G06V 40/10; G06V 2201/07

(57) ABSTRACT

A key-point associating apparatus acquires a target image in which one or more persons are captured and detects, for each person, a basis key-point and one or more target key-points from the target image. The basis key-point of the person indicates a location of a basis part of the person. The target key-point of the person indicates a location of a target part of the person. The key-point associating apparatus generates a feature map for each target part based on the target image. The feature map of the target part indicates a region connecting the basis part and the target part that belongs to the person same as the basis part. The key-point associating apparatus associates, based on the feature map, the basis key-point with the target key-point that belongs to the person same as the basis key-point.

### TECHNICAL FIELD

The present disclosure generally relates to a key-point associating apparatus, a key-point associating method, and a non-transitory computer-readable storage medium.

### BACKGROUND ART

There are various types of analysis that are performed on an image in which one or more persons are captured. Some of those analyses, such as pose estimation, use key-points of the person, such as joints of body. Specifically, the key-points are detected from the image, and divided into groups so that each group includes the key-points that belong to the same person as each other. This process of dividing the key-points into groups is called “key-point association”. NPL1 discloses one of algorithms for key-point association.

### CITATION LIST

### Non Patent Literature

NPL1: Zhe Cao, Gines Hidalgo, Tomas Simon, Shih-En Wei, and Yaser Sheikh, “OpenPose: Realtime Multi-Person 2D Pose Estimation using Part Affinity Fields”, [online], Dec. 18, 2018, [retrieved on 2022 Apr. 29], retrieved from <arXiv, https://arxiv.org/pdf/1812.08008.pdf>

### SUMMARY OF INVENTION

### Technical Problem

In NPL1, it is required to define adjacent body parts in advance. For example, neck and right waist, right waist and right knee, and right knee and right foot may be defined as adjacent parts, respectively. An objective of the present disclosure is to provide a novel technique of key-point association.

### Solution to Problem

The present disclosure provides a key-point associating apparatus comprising at least one memory that is configured to store instructions and at least one processor.

The at least one processor is configured to execute the instructions to: acquire a target image in which one or more persons are captured: detect, for each person, a basis key-point and one or more target key-points from the target image, the basis key-point of the person indicating a location of a basis part of the person, the target key-point of the person indicating a location of a target part of the person, the target part being different from the basis part; generate a feature map for each target part based on the target image, the feature map of the target part indicating, for each basis part in the target image, a region connecting the basis part and the target part that belongs to the person same as the basis part; and associate, based on the feature map, the basis key-point with one or more target key-points that belong to the person same as the basis key-point.

The present disclosure further provides a key-point associating method performed by a computer.

The key-point associating method comprises: acquiring a target image in which one or more persons are captured; detecting, for each person, a basis key-point and one or more target key-points from the target image, the basis key-point of the person indicating a location of a basis part of the person, the target key-point of the person indicating a location of a target part of the person, the target part being different from the basis part; generating a feature map for each target part based on the target image, the feature map of the target part indicating, for each basis part in the target image, a region connecting the basis part and the target part that belongs to the person same as the basis part; and associating, based on the feature map, the basis key-point with one or more target key-points that belong to the person same as the basis key-point.

The present disclosure further provides a non-transitory computer readable storage medium storing a program.

The program causes a compute to execute: acquiring a target image in which one or more persons are captured; detecting, for each person, a basis key-point and one or more target key-points from the target image, the basis key-point of the person indicating a location of a basis part of the person, the target key-point of the person indicating a location of a target part of the person, the target part being different from the basis part; generating a feature map for each target part based on the target image, the feature map of the target part indicating, for each basis part in the target image, a region connecting the basis part and the target part that belongs to the person same as the basis part; and associating, based on the feature map, the basis key-point with one or more target key-points that belong to the person same as the basis key-point.

### Advantageous Effects of Invention

According to the present disclosure, a novel technique of key-point association is provided.

### BRIEF DESCRIPTION OF DRAWINGS

FIG. 1 illustrates an overview of a key-point associating apparatus.

FIG. 2 illustrates an example of the BCF feature map.

FIG. 3 is a block diagram illustrating an example of a functional configuration of the key-point associating apparatus.

FIG. 4 is a block diagram illustrating an example of a hardware configuration of the key-point associating apparatus.

FIG. 5 is a flowchart illustrating an example flow of processes performed by the key-point associating apparatus.

FIG. 6 shows a flowchart illustrating an example flow of processes with which the key-point associating unit 2080 performs the key-point association.

FIG. 7 illustrates the candidate links and their intermediate points.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary. In addition, predetermined information (e.g., a predetermined value or a predetermined threshold) is stored in advance in a storage device to which a computer using that information has access unless otherwise described.

### Overview

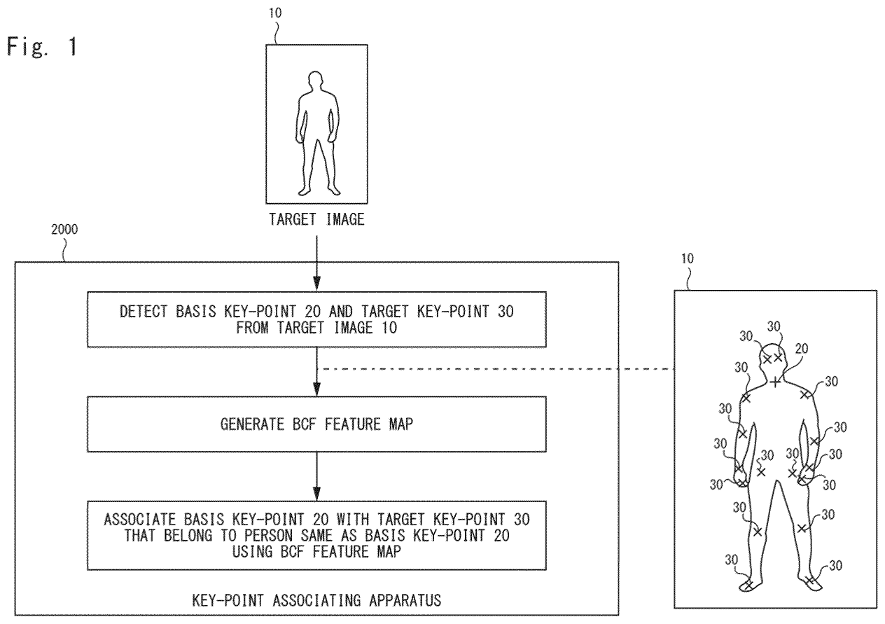

FIG. 1 illustrates an overview of a key-point associating apparatus 2000 of an example embodiment. It is noted that the overview illustrated by FIG. 1 shows an example of operations of the key-point associating apparatus 2000 to make it easy to understand the key-point associating apparatus 2000, and does not limit or narrow the scope of possible operations of the key-point associating apparatus 2000.

The key-point associating apparatus 2000 acquires a target image 10 in which one or more persons are captured, detects key-points from the target image 10, and performs key-point association on the detected key-points. The target image 10 may be arbitrary type of image data, such as RGB image or grayscale image, in which persons can be captured in a visible manner. The key-point may indicate a characteristic point (e.g., joint) of human's body.

The key-points belonging to a particular person include a basis key-point 20 and one or more target key-points 30. The basis key-point 20 of a particular person indicates the location (i.e., coordinates on the target image 10) of a predefined basis part of the person, whereas the target key-points 30 of a particular person indicates the location of predefined target parts of the person different from each other. The basis part may be a representative one of characteristic parts of human's body, such as neck. The target parts may be characteristic parts of human's body other than the basis part, such as a right eye, a left shoulder, etc.

Suppose that the basis part is neck, and the target parts include 16 parts of human's body: right eye, right ear, right shoulder, right elbow, right hand, right waist, right knee, right foot, left eye, left ear, left shoulder, left elbow, left hand, left waist, left knee and left foot. In this case, the key-point associating apparatus 2000 may detect a point of neck as the basis key-point 20 and points of those 16 target parts as the target key-points 30 for each person from the target image 10.

After detecting the key-points, the key-point associating apparatus 2000 performs the key-point association. The key-point association is a process to associate the basis key-point 20 with the target key-points 30 that belong to the same person as the basis key-point 20, for each basis key-point 20 detected from the target image 10. In other words, the key-point association is a process to make, for each person, a group of the key-points belonging to that person. Hereinafter, the group of the key-points that belong to the same person as each other is called “key-point group”.

In the key-point association process, the key-point associating apparatus 2000 analyzes the target image 10 to generate a map called “BCF (Body Crosscutting Field) feature map” for each target part. For example, when the above-mentioned 16 target parts are defined, the key-point associating apparatus 2000 generates the BCF feature map for each of those 16 target parts: the BCF feature map of the right eye, the BCF feature map of the right shoulder, etc.

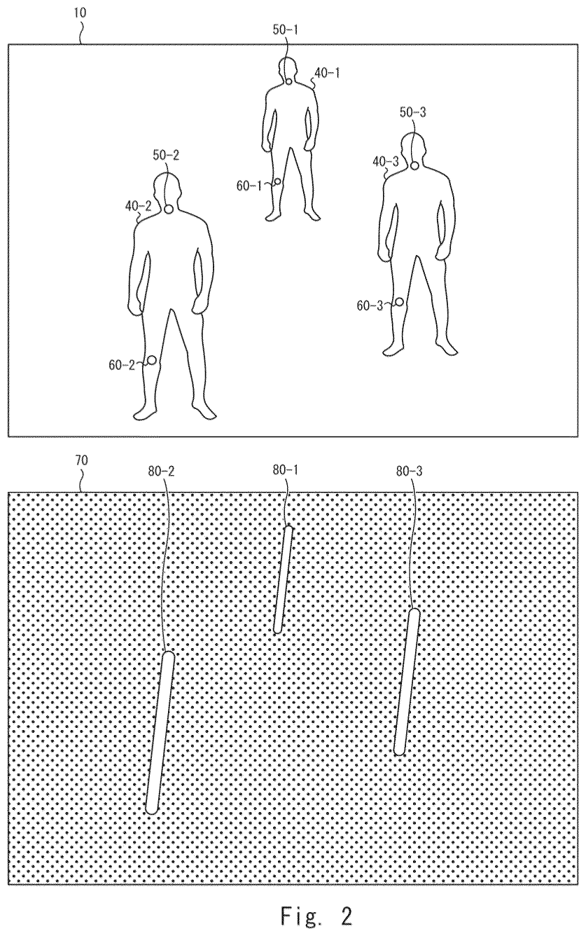

The BCF feature map of a particular target part indicates, for each basis part included in the target image 10, a region called “BCF region” that connects the basis part with the target part that belong to the same person as each other. FIG. 2 illustrates an example of the BCF feature map. In this example, neck is defined as the basis part. The target image 10 from which the BCF feature map 70 is generated includes three persons 40-1 to 40-3. The necks 50-1 to 50-3 are the basis parts of the persons 40-1 to 40-3, respectively.

In FIG. 2, the BCF feature map 70 is generated for right knee. Thus, the BCF feature map 70 indicates, for each of the necks 50 included in the target image 10, the BCF region 80 that connects the neck 50 and the right knee 60 that belong to the same person as each other. For example, the BCF region 80-1 connects the neck 50-1 and the right knee 60-1 that belong to the person 40-1.

The key-point associating apparatus 2000 uses the BCF feature maps to associates the basis key-point 20 with the target key-point 30 that belong to the same person as the basis key-point 20. As a result of the key-point association, the key-point associating apparatus 2000 may obtain, for each basis key-point 20, the key-point group that includes the basis key-point 20 and the target key-points 30 that are associated with each other. This means that the key-point group includes the basis key-point 20 and the target key-points 30 that belong to the same person as each other.

### Example of Advantageous Effect

According to the key-point associating apparatus 2000, a novel concept called “BCF feature map” is introduced for key-point association. Specifically, the key-point associating apparatus 2000 generates the BCF feature map 70 for each target part and uses them to associate the basis key-point 20 and the target key-point 30 that belong to the same person as each other. Thus, a novel technique for key-point association is provided.

The key-point association with BCF feature maps performed by the key-point associating apparatus 2000 is advantageous over the key-point association performed by NPL1 as follows. NPL1 proposes a concept called “PAF (Part Affinity Field)” to associate the key-points. PAF is an area between two adjacent key-points on human body. Each pixel in PAF is annotated with a unit vector from one key-point to another. After generating PAF feature maps from original image throughout a pre-trained neural network, the integral of vector of each pixel in the PAF can be referred to as the expectation of associating the two key-points.

In NPL1, the PAF is defined only between adjacent key-points. Due to this restriction, even a single error in the association of adjacent key-points can cause a critical failure in key-point association. Suppose that there are two persons P1 and P2 in an image to be analyzed, and key-points of neck and right waist, those of right waist and right knee, and those of right knee and right foot are defined pairs of adjacent key-points, respectively.

In this situation, if a neck key-point of the person P1 is associated to a right waist key-point of the person P2 due to low quality of PAF, the neck key-point of the person Pl would not be associated any key-points of the person P1. Specifically, the right waist key-point of the person P2 may be associated with the right knee key-point of the person P2. Then, the right knee key-point of the person P2 may be associated with the right foot key-point of the person P2. As a result, the neck key-point of the person P1, the right waist key-point of the person P2, the right knee key-point of the person P2, and the right food key-point of the person P2 are connected in this order.

On the other hand, since the BCF feature map 70 is generated for each target part to describe a spatial relationship between the basis part and the target part, the key-point associating apparatus 2000 can individually associate the target key-point 30 with the basis key-point 20. Thus, an error in association between a target key-point 30 and the basis key-point 20 does not cause additional errors in association between other target key-points 30 and the basis key-point 20. This means that the key-point associating apparatus 2000 can perform key-point association more accurately than the system disclosed by NPL1.

Hereinafter, more detailed explanation of the key-point associating apparatus 2000 will be described.

### Example of Functional Configuration

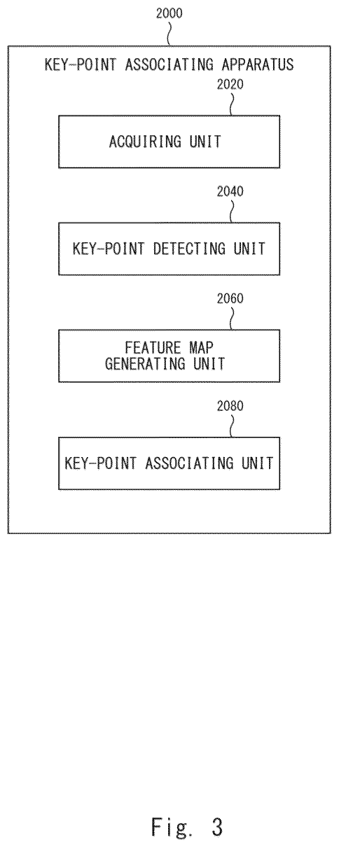

FIG. 3 is a block diagram illustrating an example of the functional configuration of the key-point associating apparatus 2000 of the example embodiment. The key-point associating apparatus 2000 includes an acquiring unit 2020, a key-point detecting unit 2040, a feature map generating unit 2060, and a key-point associating unit 2080. The acquiring unit 2020 acquires the target image 10. The key-point detecting unit 2040 detects one or more basis key-points 20 and one or more target key-points 30 from the target image 10. The feature map generating unit 2060 uses the target image 10 to generate, for each target part, the BCF feature map 70 that includes the BCF region for each basis part included in the target image 10. The key-point associating unit 2080 uses the BCF feature maps to associate the basis key-point 20 with the target key-point 30 that belong to the same person as the basis key-point 20.

### Example of Hardware Configuration

The key-point associating apparatus 2000 may be realized by one or more computers. Each of the one or more computers may be a special-purpose computer manufactured for implementing the key-point associating apparatus 2000, or may be a general-purpose computer like a personal computer (PC), a server machine, or a mobile device.

The key-point associating apparatus 2000 may be realized by installing an application in the computer. The application is implemented with a program that causes the computer to function as the key-point associating apparatus 2000. In other words, the program is an implementation of the functional units of the key-point associating apparatus 2000.

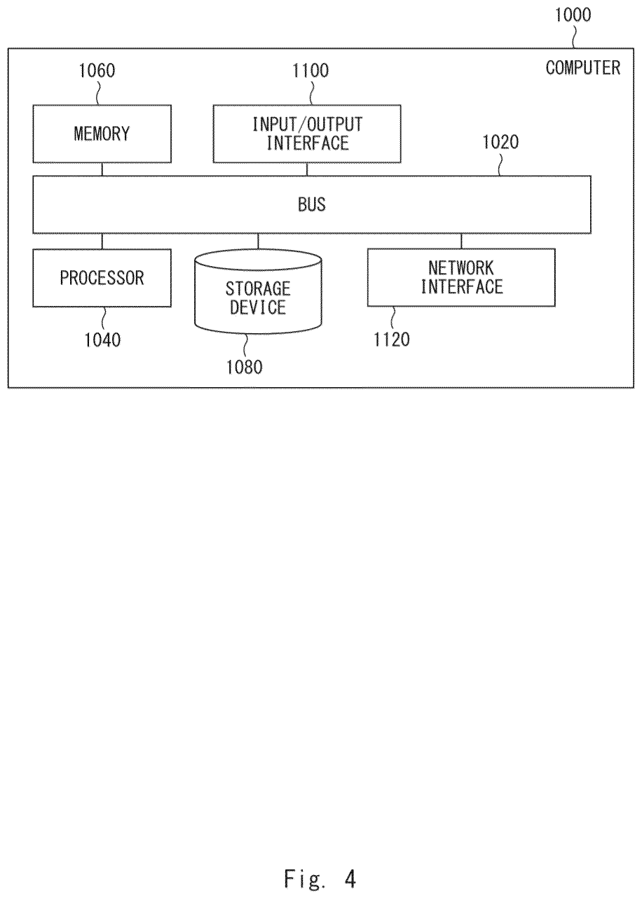

FIG. 4 is a block diagram illustrating an example of the hardware configuration of a computer 1000 realizing the key-point associating apparatus 2000 of the example embodiment. In FIG. 4, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), DSP (Digital Signal Processor), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The hardware configuration of the computer 1000 is not restricted to that shown in FIG. 4. For example, as mentioned-above, the key-point associating apparatus 2000 may be realized as a combination of multiple computers. In this case, those computers may be connected with each other through the network.

### Flow of Process

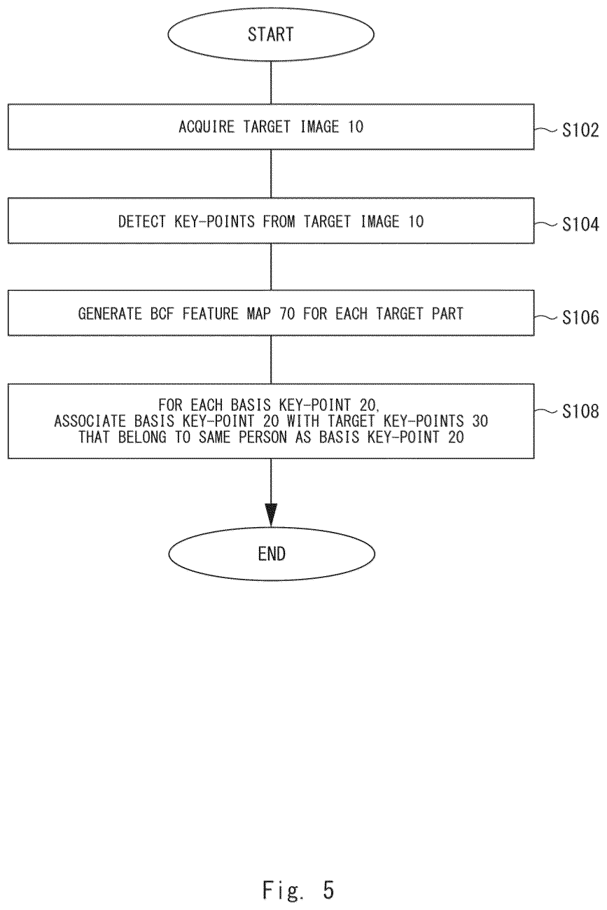

FIG. 5 is a flowchart illustrating an example flow of processes performed by the key-point associating apparatus 2000 of the example embodiment. The acquiring unit 2020 acquires the target image 10 (S102). The key-point detecting unit 2040 detects the key-points from the target image 10 (S104). The feature map generating unit 2060 generates the BCF feature map 70 for each target part (S106). For each basis key-point 20, the key-point associating unit 2080 associates the basis key-point 20 with the target key-points 30 that belong to the same person as the basis key-point 20 (S108).

### Acquisition of Target Image 10: S102

The acquiring unit 2020 acquires the target image 10 (S102). There are various ways to acquire the target image 10. In some embodiments, the target image 10 is stored in advance in a storage device in a manner that the key-point associating apparatus 2000 can acquire it. In this case, the acquiring unit 2020 may access the storage device to acquire the target image. In other embodiments, the target image 10 may be sent by another computer, such as a camera that generates the target image 10. In this case, the acquiring unit 2020 may acquire the target image 10 by receiving it.

In some embodiments, the target image 10 may be one of time-series images, such as time-series video frames constituting a video. In this case, the key-point associating apparatus 2000 may acquire all or a part of the time-series images as the target images 10, and perform key-point detection and key-point association for each of the target images 10.

### Detection of Key-points: S104

The key-point detecting unit 2040 detects the basis key-point 20 and the target key-points 30 from the target image 10 (S104). There are various ways to detect one or more locations of predefined parts of human's body as key-points from an image, and the key-point detecting unit 2040 may use one of those ways to detect the basis key-point 20 and the target key-point 30 from the target image 10.

In some embodiments, the key-point detecting unit 2040 includes a machine learning-based model (e.g., a neural network) that is configured to take an image as input and that is trained in advance to detect one or more basis key-points 20 and one or more target key-points 30 for each target part from the input image in response to the input image being input thereto. Hereinafter, this model is called “key-point detecting model”.

The key-point detecting model may take the target image 10 as input, extract features from the target image 10, detect one or more locations of each of the predefined parts (basis part and target parts) of human's body based on the extracted features, and output pairs of the location and the label as key-points. The label of the key-point indicates which part of human's body is indicated by the key-point. In this case, the key-point detecting model may include a first model that is trained in advance to extract the features from the target image 10, and a second model that is trained in advance to detect one or more locations of each predefined part of human's body based on the features extracted by the first model. Each of the first model and the second model may be configured as a machine learning-based model, such as a neural network. It is noted that there are various types of machine-learning models that can detect key-points from an input image, and the key-point detecting model can be configured as one of such models.

### Generation of BCF Feature Map: S106

For each predefined target part, the feature map generating unit 2060 generates the BCF feature map 70 (S106). As mentioned above, the BCF feature map 70 of a particular target part includes, for each basis part, the BCF region 80 that connects the basis part and the target part that belong to the same person as each other. The BCF feature map 70 may be an image data with the same dimensions (i.e., height and width) as those of the target image 10. The values of pixels within the BCF region 80 are set to be different (e.g., larger) than those outside the BCF region 80. For example, the values of pixels within the BCF region 80 may be set to 1, whereas those outside the BCF region 80 may be set to 0.

In order to generate the BCF feature map 70, the feature map generating unit 2060 may include a machine learning-based model called “feature map generating model” for each predefined target part. The feature map generating model of a particular target part is configured to take an image, and trained in advance to generate the BCF feature map 70 for the target part in response to the input image being input thereto. When values of the pixels in BCF areas are defined as being larger than those outside BCF areas, the feature map generating model of a particular target part generates the BCF feature map 70 of the target part where the value of the pixel is larger as the pixel is more likely to be included in the BCF region 80 of the target part. The feature map generating unit 2060 may input the target image 10 to each feature map generating model, thereby obtaining the BCF feature map 70 for each target part from the corresponding feature map generating model.

The feature map generating model is trained using multiple training data sets each of which includes a training input image and a ground-truth BCF feature map. The training input image is an image data on which one or more persons are captured similar to the target image 10. The ground-truth BCF feature map is an ideal BCF feature map that should be output from the learnt feature map generating model in response to the corresponding training input image being input thereto. The training datasets are prepared for each target part.

The ground-truth BCF feature map may be generated in advance by an administrator or the like of the key-point associating apparatus 2000. For example, the administrator or the like operates a computer, called “dataset generating apparatus”, to display a training input image on a display device. The administrator or the like specifies a type of target part for which she or he wants to generate the BCF feature map 70. Then, the administrator or the like specifies, for each person included in the training input image, locations of the basis part and the target part that belong to the person. Based on the specification of one or more pairs of the basis part and the target part, the dataset generating apparatus generates the BCF feature map 70 of the selected target part.

Specifically, the dataset generating apparatus may initialize the BCF feature map 70 so that the BCF feature map 70 has the same dimensions as the training input image and has pixels with a predefined first value (e.g., zero) indicating that the corresponding pixel is located outside BCF regions 80. Then, the dataset generating apparatus may determine one or more the BCF regions 80 based on the specification of one or more pairs of the basis part and the target part, and set the values of the pixels in the BCF regions 80 to a predefined second value (e.g., one) indicating that the corresponding pixel is located in a BCF region 80.

The BCF region 80 may be drawn with a predefined shape, such as rectangle or stadium. It is noted that the width (i.e., length in a direction perpendicular to the direction from the basis part to the target part) of the BCF region 80 may be defined as a fixed value, or may be dynamically determined as a value based on (e.g., proportional to) the distance between the basis part and the target part.

The feature map generating model may be trained by the key-point associating apparatus 2000 or another computer. Hereinafter, an apparatus that trains the feature map generating model is called “training apparatus”. In some embodiments, the feature map generating model of a particular target part may be trained as follows. The training apparatus selects one of the training datasets of the target part, inputs the training input image of the selected training dataset into the feature map generating model of the target part, and obtains an output therefrom. Then, the training apparatus applies the obtained output and the ground-truth BCF feature map of the selected training dataset to a predefined loss function to compute a loss. The training apparatus updates trainable parameters (e.g., weights and biases of a neural network) of the feature map generating model of the target part. The feature map generating model of the target type may be trained by repeatedly performing the above processes.

### Key-point Association: S108

The key-point associating unit 2080 associates the basis key-point 20 with the target key-points 30 that belong to the same person as the basis key-point 20 (S108). In other words, the key-point associating unit 2080 generates the key-point group for each basis key-point 20. Specifically, the key-point associating unit 2080 may initialize the key-point group for each basis key-point 20. Then, the key-point associating unit 2080 determines, for each basis key-point 20, the target key-points 30 that belong to the same person as the basis key-point 20, and assigns the determined target key-points 30 to the key-point group of the basis key-point 20.

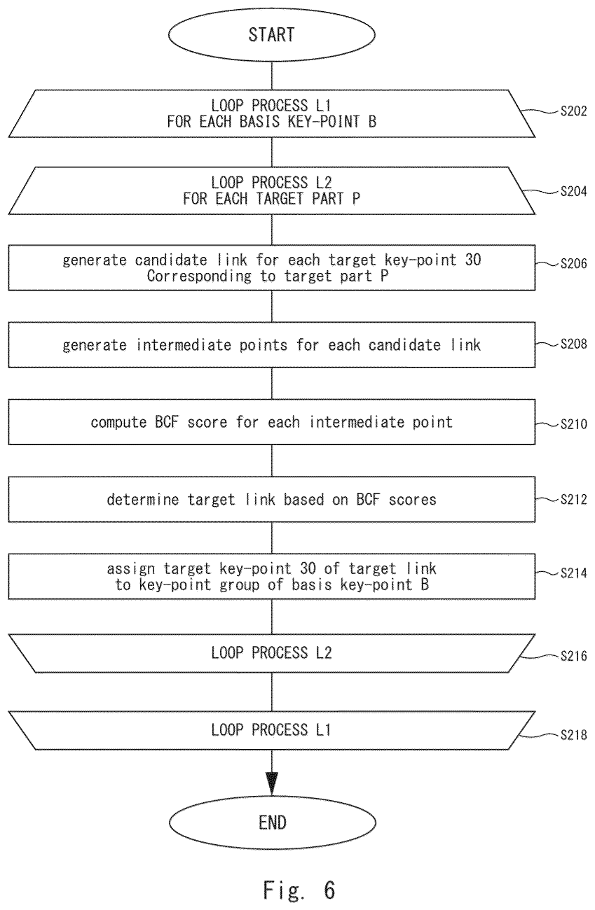

As mentioned above, the key-point associating unit 2080 uses the BCF feature maps 70 for key-point association. The BCF feature map 70 may be used as follows. FIG. 6 shows a flowchart illustrating an example flow of processes with which the key-point associating unit 2080 performs the key-point association. Steps S202 to S218 constitutes a loop process L1 that is performed for each basis key-point 20. In Step S202, the key-point associating unit 2080 determines whether or not the loop process L1 has been already performed for every basis key-point 20. In the case where the loop process L1 has been already performed for every basis key-point 20, the key-point associating unit 2080 terminates the key-point association. On the other hand, in the case where the loop process L1 has not been performed for every basis key-point yet, the key-point associating unit 2080 chooses one of the basis key-points 20 for which the loop process L1 is not performed yet. The basis key-point 20 chosen here is denoted by “basis key-point B” hereinafter.

Steps S204 to S216 constitutes a loop process L2 that is performed for each target part. Through the repetitive executions of the loop process L2 in an iteration of the loop process L1, the key-point associating unit 2080 determines the target key-points 30 that belong to the same person as the basis key-point B corresponding to the iteration of the loop process L1.

In Step S204, the key-point associating unit 2080 determines whether or not the loop process L2 has been already performed for every target part in the current iteration of the loop process L1. In the case where the loop process L2 has been already performed for every target part in the current iteration of the loop process L1, the key-point associating unit 2080 terminates the loop process L2 in the current iteration of the loop process L1. Then, the key-point associating unit 2080 terminates the current iteration of the loop process L1 (S218), and thus proceeds to the next iteration of the loop process L1 (S202).

On the other hand, in the case where the loop process L2 has not been performed for every target part yet in the current iteration of the loop process L1, the key-point associating unit 2080 chooses one of the target parts for which the loop process L2 is not performed yet in the current iteration of the loop process L1. The target part chosen here is denoted by “target part P” hereinafter.

The key-point associating unit 2080 generates, for each target key-point 30 corresponding to the target part P, a candidate link that represents a line between that target key-point 30 and the basis key-point B. (S206). The key-point associating unit 2080 generates intermediate points for each candidate link (S208). The intermediate points of a particular candidate link may be points on the candidate link that divides the candidate link into multiple lines with the same length as each other. The number of intermediate points on a single candidate link may be defined in advance.

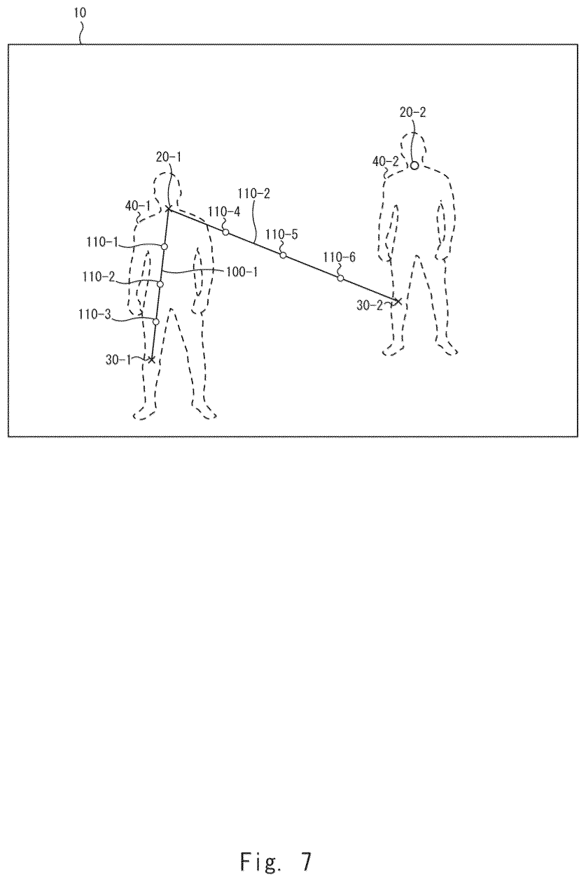

FIG. 7 illustrates the candidate links and their intermediate points. There are two persons 40-1 and 40-2 in the target image 10 shown by FIG. 7. The basis key-point B is the basis key-point 20-1: i.e., the neck key-point of the person 40-1. The target part P is right knee.

In this example, the key-point associating unit 2080 generates two candidate links: the candidate link 100-1 that connects the basis key-point B (the basis key-point 20-1) with the target key-point 30-1 that is the key-point of the right knee of the person 40-1: and the candidate link 100-2 that connects the basis key-point B with the target key-point 30-2 that is the key-point of the right knee of the person 40-2.

The key-point associating unit 2080 generates three intermediate points for each candidate link. Specifically, the candidate link 100-1 has the intermediate points 110-1 to 110-3, whereas the candidate link 100-2 has the intermediate points 110-4 to 110-6.

The key-point associating unit 2080 computes a BCF score for each intermediate point (S210). Specifically, the BCF score of a particular intermediate point is the value of the pixel of the BCF feature map 70 of the target part P at the same coordinates as those of the intermediate point. For example, when there is an intermediate point at (x1, y1) on the target image 10, the BCF score of the intermediate point is obtained from the pixel at (x1, y1) of the BCF feature map 70 of the target part P.

Based on the BCF scores computed for the intermediate points, the key-point associating unit 2080 determines a target link, which connects the basis key-point B with the target key-point 30 that belongs to the same person as the basis key-point B (S212). Then, the key-point associating unit 2080 assigns the target key-point 30 of the target link to the key-point group of the basis key-point B (S214).

Since S216 is the end of the loop process L2, the key-point associating unit 2080 terminates the current iteration of the loop process L2, and then proceeds to the next iteration of the loop process L2 (S204).

In S212, the key-point associating unit 2080 may compute a total value (called “total BCF score”, hereinafter) of the BCF scores of the intermediate points on the candidate link for each candidate link. Then, the key-point associating unit 2080 determines the candidate link with the largest total BCF score as the target link.

Suppose that there are two candidate links L1 and L2. The candidate link L1 includes three intermediate points: I11 with the BCF score S11: I12 with the BCF score S12: and I13 with the BCF score S13. The candidate link L2 includes three intermediate points: I21 with the BCF score S21: I22 with the BCF score S22; and I13 with the BCF score S23. In this case, the total BCF score TS1 of the candidate link L1 is S11+S12+S13, whereas the total BCF score TS2 of the candidate link L2 is S21+S22+S23.

When TS1 is larger than TS2, the key-point associating unit 2080 determines the candidate link L1 as the target link. On the other hand, when TS2 is larger than TS1, the key-point associating unit 2080 determines the candidate link L2 as the target link.

It is noted that there may be defined a minimum threshold of the total BCF score. In this case, the key-point associating unit 2080 determines whether or not the largest total BCF score is larger than the minimum threshold. When the largest total BCF score is larger than or equal to the minimum threshold, the key-point associating unit 2080 determines the candidate link with the largest BCF score as the target link. On the other hand, the largest total BCF score is not larger than the minimum threshold, the key-point associating unit 2080 determines that there is no candidate link to be determined as the target link. In this case, no target key-point 30 of the target part P is assigned to the key-point group of the basis key-point B.

The key-point associating unit 2080 may also take a variance of the BCF scores of the candidate link into consideration. In this case, a maximum threshold of variance of BCF scores is defined in advance. The key-point associating unit 2080 may determine one or more candidate links that have the total BCF score larger than or equal to the minimum threshold of the total BCF score and have the variance of BCF scores less than or equal to the maximum threshold of the variance of BCF scores. Then, from those determined candidate links, the key-point associating unit 2080 may choose the candidate link with the largest total BCF as the target link.

It is noted that an appropriate value of the minimum threshold of the total BCF score may depend on the number of the intermediate points. Thus, the key-point associating unit 2080 may use the mean value of BCF scores instead of the total BCF score. In this case, the minimum threshold of the mean value of BCF scores is used instead of the minimum threshold of the total BCF score.

### Output from Key-Point Associating Apparatus 2000

The key-point associating apparatus 2000 may be configured to output information (called output information) that shows the result of the key-point association. For example, the output information may include an identifier (e.g., frame number) of the target image 10 and key-point group information. The key-point group information includes, for each key-point group, an identifier of the key-point group and key-point information of each key-point in the key-point group. The key-point information indicates an identifier of the key-point, the location indicated by the key-point, and an identifier of the part of human's body indicated by the key-point.

There are various ways to output the output information. In some implementations, the output information may be put into a storage device, displayed on a display device, or sent to another computer such as a PC or smart phone of the user of the key-point associating apparatus 2000.

### Usage of Key-Point Group

There are various usages of the result of the key-point association (i.e., the key-point groups). For example, the key-point group can be used for pose estimation. As a result of the pose estimation, for each key-point group, the type of the pose taken by the person corresponding to the key-point group can be estimated.

In addition, by performing pose estimation for each of the target images 10 in a time-series data (e.g., video frames in a video), a time-series of poses can be obtained for each person captured in the target image 10. The time-series of poses of the person may be used to determine an action or a time-series of actions taken by the person.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

### REFERENCE SIGNS LIST

10 target image
20 basis key-point
30 target key-point
40 person
50 neck
60 right knee
70 BCF feature map
80 BCF region
100 candidate link
110 intermediate point
1000 computer
1020 bus
1040 processor
1060 memory
1080 storage device
1100 input/output interface
1120 network interface
2000 key-point associating apparatus
2020 acquiring unit
2040 key-point detecting unit
2060 feature map generating unit
2080 key-point associating unit

What is claimed is:

1. A key-point associating apparatus comprising:
at least one memory that is configured to store instructions; and
at least one processor that is configured to execute the instructions to:
acquire a target image in which one or more persons are captured;
detect, for each person, a basis key-point and one or more target key-points from the target image, the basis key-point of the person indicating a location of a basis part of the person, the target key-point of the person indicating a location of a target part of the person, the target part being different from the basis part;
generate a feature map for each target part based on the target image, the feature map of the target part indicating, for each basis part in the target image, a region connecting the basis part and the target part that belongs to the person same as the basis part; and
associate, based on the feature map, the basis key-point with one or more target key-points that belong to the person same as the basis key-point.

2. The key-point associating apparatus according to claim 1,
wherein each pixel in the region of the feature map has a value larger than values of pixels outside the region of the feature map.

3. The key-point associating apparatus according to claim 2,
wherein the association of the basis key-point with one or more target key-points includes, for each basis key-point:
for each target part, performing:
generating, for each target key-point indicating the location of the target part, a candidate link that is a line connecting the basis key-point with the target key-point;
generating multiple intermediate points that divide the candidate link into a pre-defined number of lines;
acquiring, for each intermediate point, from the feature map of the target part, the value of the pixel at the intermediate point as a score of the intermediate point;
determining one of the candidate links as a target link based on one or more statistics of the scores of the intermediate points of each candidate link; and
associating the basis key-point with the target key-point of the target link.

4. The key-point associating apparatus according to claim 3,
wherein the target link is the candidate link whose total value or mean value of the scores of the intermediate points is largest of the candidate links.

5. The key-point associating apparatus according to claim 4,
wherein the target link is the candidate link whose total value or mean value of the scores of the intermediate points is larger than or equal to a predefined first threshold.

6. The key-point associating apparatus according to claim 5,
wherein the target link is the candidate link whose variance of the scores of the intermediate points is less than or equal to a predefined second threshold.

7. The key-point associating apparatus according to claim 1,
wherein the at least one memory stores a machine learning-based model for each target part that is configured to take the target image as input and to output the feature map of the target part in response to the target image being input thereinto, and
wherein the generation of the feature map of the target part includes:
inputting the target image into the model of the target part; and
acquiring the feature map of the target part that is output from the model of the target part.

8. A key-point associating method performed by a computer, comprising:
acquiring a target image in which one or more persons are captured;
detecting, for each person, a basis key-point and one or more target key-points from the target image, the basis key-point of the person indicating a location of a basis part of the person, the target key-point of the person indicating a location of a target part of the person, the target part being different from the basis part;
generating a feature map for each target part based on the target image, the feature map of the target part indicating, for each basis part in the target image, a region connecting the basis part and the target part that belongs to the person same as the basis part; and
associating, based on the feature map, the basis key-point with one or more target key-points that belong to the person same as the basis key-point.

9. The key-point associating method according to claim 8,
wherein each pixel in the region of the feature map has a value larger than values of pixels outside the region of the feature map.

10. The key-point associating method according to claim 9,
wherein the association of the basis key-point with one or more target key-points includes, for each basis key-point:
for each target part, performing:
generating, for each target key-point indicating the location of the target part, a candidate link that is a line connecting the basis key-point with the target key-point;
generating multiple intermediate points that divide the candidate link into a pre-defined number of lines;
acquiring, for each intermediate point, from the feature map of the target part, the value of the pixel at the intermediate point as a score of the intermediate point;
determining one of the candidate links as a target link based on one or more statistics of the scores of the intermediate points of each candidate link; and
associating the basis key-point with the target key-point of the target link.

11. The key-point associating method according to claim 10,
wherein the target link is the candidate link whose total value or mean value of the scores of the intermediate points is largest of the candidate links.

12. The key-point associating method according to claim 11,
wherein the target link is the candidate link whose total value or mean value of the scores of the intermediate points is larger than or equal to a predefined first threshold.

13. The key-point associating method according to claim 12,
wherein the target link is the candidate link whose variance of the scores of the intermediate points is less than or equal to a predefined second threshold.

14. The key-point associating method according to claim 8,
wherein the computer stores a machine learning-based model for each target part that is configured to take the target image as input and to output the feature map of the target part in response to the target image being input thereinto, and
wherein the generation of the feature map of the target part includes:
inputting the target image into the model of the target part; and
acquiring the feature map of the target part that is output from the model of the target part.

15. A non-transitory computer-readable storage medium storing a program that causes a compute to execute:
acquiring a target image in which one or more persons are captured;
detecting, for each person, a basis key-point and one or more target key-points from the target image, the basis key-point of the person indicating a location of a basis part of the person, the target key-point of the person indicating a location of a target part of the person, the target part being different from the basis part;
generating a feature map for each target part based on the target image, the feature map of the target part indicating, for each basis part in the target image, a region connecting the basis part and the target part that belongs to the person same as the basis part; and
associating, based on the feature map, the basis key-point with one or more target key-points that belong to the person same as the basis key-point.

16. The storage medium according to claim 15,
wherein each pixel in the region of the feature map has a value larger than values of pixels outside the region of the feature map.

17. The storage medium according to claim 16,
wherein the association of the basis key-point with one or more target key-points includes, for each basis key-point:
for each target part, performing:
generating, for each target key-point indicating the location of the target part, a candidate link that is a line connecting the basis key-point with the target key-point;
generating multiple intermediate points that divide the candidate link into a pre-defined number of lines;
acquiring, for each intermediate point, from the feature map of the target part, the value of the pixel at the intermediate point as a score of the intermediate point;
determining one of the candidate links as a target link based on one or more statistics of the scores of the intermediate points of each candidate link; and
associating the basis key-point with the target key-point of the target link.

18. The storage medium according to claim 17,
wherein the target link is the candidate link whose total value or mean value of the scores of the intermediate points is largest of the candidate links.

19. The storage medium according to claim 18,
wherein the target link is the candidate link whose total value or mean value of the scores of the intermediate points is larger than or equal to a predefined first threshold.

20. The storage medium according to claim 19,
wherein the target link is the candidate link whose variance of the scores of the intermediate points is less than or equal to a predefined second threshold.

21. (canceled)
